(19) United States
(12) Patent Application Publication
(10) Pub. No.: US 2006/0290113 A1
(43) Pub. Date: Dec. 28, 2006

(54) Headliner airbag

(75) Inventors: Albert R. Bernat, Rochester Hills, MI (US); James P. Karlow, Milford, MI (US)

Correspondence Address: FOLEY AND LARDNER LLP;SUITE 500, 3000 K STREET NW, WASHINGTON, DC, 20007, US

(73) Assignee: TAKATA RESTRAINT SYSTEMS, INC.

(21) Appl. No.: 11/167,384

(22) Filed: Jun. 28, 2005

(51) Int. Cl. B60R 21/22

(52) U.S. Cl. 280/730.1

(57) ABSTRACT

Systems and methods of vehicle protection increase the amount of safety provided for the occupants of the vehicle. The disclosed systems and methods are particularly useful in the event of a rollover or roof deformation. In one aspect, a vehicle airbag system includes an inflatable airbag positioned on an interior surface of a vehicle, the vehicle including a roof surface and one or more side surfaces. The airbag, when deployed, is adapted to from a cushion between the roof surface and occupants of the vehicle.

### BACKGROUND OF THE INVENTION

The present invention relates generally to the field of vehicle safety systems. In particular, the invention relates to a cushioning device deployable from a vehicle headliner.

Airbag systems are now a standard safety feature in most passenger vehicles. Conventional systems are designed to protect the driver and other occupants from head-on, rear-end and side-impact collisions. In this regard, passenger vehicles are equipped with sensors which can detect the location and direction of the collision and deploy one or more airbags within the vehicle. Airbags may deploy from the steering wheel of the vehicle to protect the driver by cushioning the impact of the driver's head to the front of the vehicle, including the windshield, for example. A front airbag may also deploy from the dash in front of the front passenger seat.

Recently, side curtain airbags have been introduced to protect front and rear occupants from side impacts. Such side curtain airbags may deploy from the roof of the vehicle downward along the side of the vehicle.

In addition to the above-mentioned types of collisions, rollovers are also a major safety hazard, particularly for larger vehicles with a higher center of gravity, such as many sports utility vehicles. Roll over type accidents pose a particular hazard for inward deformation of the vehicle roof, posing the possibility of contact between an occupant's head and the deformed roof. Existing airbag systems do not offer any protection against such threats.

### SUMMARY OF THE INVENTION

One aspect of the invention relates to a vehicle airbag system. The vehicle airbag system includes an inflatable airbag positioned on an interior surface of a vehicle, the vehicle including a roof surface and one or more side surfaces. The airbag, when deployed, is adapted to form a cushion between the roof surface and occupants of the vehicle.

In a particular embodiment, the inflatable airbag, when undeployed, is positioned within a headliner on the roof surface. The inflatable airbag may include one or more fabric bags positioned between the headliner and the inner surface of the roof. The inflatable airbag, when undeployed, may be folded in pleats within the headliner. When deployed, the inflatable airbag may protrude through the headliner.

In one embodiment, the inflatable airbag is a cavity formed between the headliner and the roof surface. When the airbag is deployed, the cavity expands to form a cushion.

In a particular embodiment, the vehicle airbag system further includes at least one sensor to facilitate detection of a rollover of the vehicle and a controller adapted to deploy the inflatable airbag when a rollover is detected. The controller may be further adapted to actuate one or more actuators to inflate the airbag when a rollover is detected.

In another aspect, the invention includes a method for providing airbag protection for vehicle occupants. The method includes detecting a rollover and deploying one or more airbags, at least one or the airbags being an inflatable airbag positioned on an interior surface of a vehicle, said inflatable airbag, when deployed, being adapted to form a cushion between the roof surface and occupants of the vehicle.

### BRIEF DESCRIPTION OF THE DRAWINGS

FIG. 1 is a cross-sectional side view of a vehicle with an airbag system in an undeployed state according to one embodiment of the invention;

FIG. 2 is a cross-sectional side view of the vehicle of FIG. 1 with the airbag system in a deployed state;

FIG. 3 is a cross-sectional side view of a vehicle with an airbag system in an undeployed state according to another embodiment of the invention;

FIG. 4 is a cross-sectional side view of the vehicle of FIG. 3 with the airbag system in a deployed state; and

FIG. 5 is a schematic illustration of an airbag control system.

### DETAILED DESCRIPTION

Embodiments of the present invention provide systems and methods of vehicle protection which increase the amount of safety provided for the occupants of the vehicle. The disclosed embodiments are particularly useful in the event of a rollover or a roof deformation.

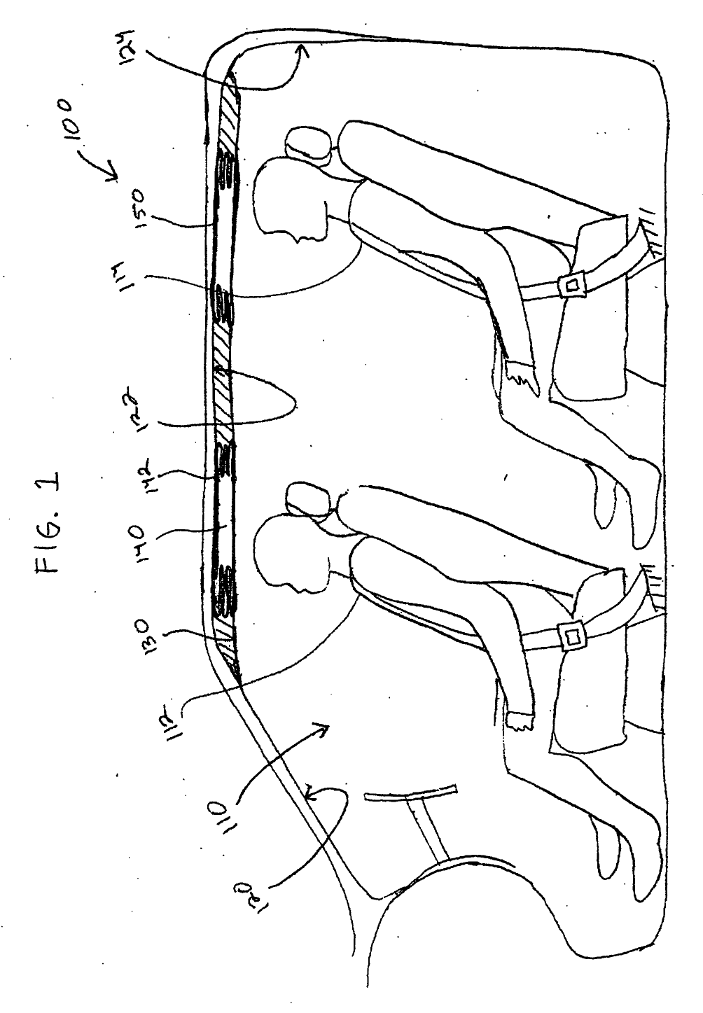

Referring to FIG. 1, a vehicle with an airbag system according to an embodiment of the invention is illustrated. The vehicle 100 may be any passenger vehicle such as a car, a van, a minivan or a sports utility vehicle, for example. The vehicle 100 includes a passenger compartment 110 in which a front seat passenger 112 and a rear-seat passenger 114 are shown. The size of the passenger compartment 110 may vary greatly according to the type of vehicle. Each of the front row and the rear row of seats may accommodate multiple passengers. Further, vehicles may be equipped with more or fewer rows of seats. For example, some vehicles may only have one row of seats, while others, such as minivans, may include three or more rows.

The passenger compartment 110 is enclosed by the interior surface 120 of the vehicle 100, which includes a roof surface 122 and side surfaces, such as the rear surface 124. The interior surface 120 may be made of a variety of materials and may include different materials in different portions of the same vehicle. Commonly used materials may include metals, such as steel, or composites. Further, the interior surface 120 may include windows formed of tempered glass, for example.

The interior surface 120 of most vehicles is provided with upholstery covering much of the surfaces. In the illustrated embodiment, the roof surface 122 is covered with a headliner 130. The headliner 130 may be formed of any of a variety of materials or a combination of materials. For example, the headliner may be formed of a fabric with a thin layer of foam cushioning. The headliner 130 may cover the entire roof surface or a portion thereof. Further, in some embodiments, the headliner 130 may be integrally formed with upholstery for other surface of the interior surface 120, such as the rear surface 124.

In embodiments of the invention, one or more inflatable airbags are provided on the interior surface of the vehicle. In the embodiment illustrated in FIG. 1, inflatable airbags 140, 150 are provided on the roof surface within the headliner 130. In the undeployed state, as illustrated in FIG. 1, the airbags 140, 150 are positioned within cutout regions of the headliner. In this manner, the airbags 140, 150 do not affect the aesthetic appearance of the vehicle.

The inflatable airbags 140, 150 illustrated in FIG. 1 include fabric bags positioned between the headliner and the roof surface. The fabric bags may be formed of fabrics similar to those used in conventional airbags. To position the airbags 140, 150 within the headliner 130, the airbags may be folded with pleats 142 so to make the undeployed airbag substantially flat.

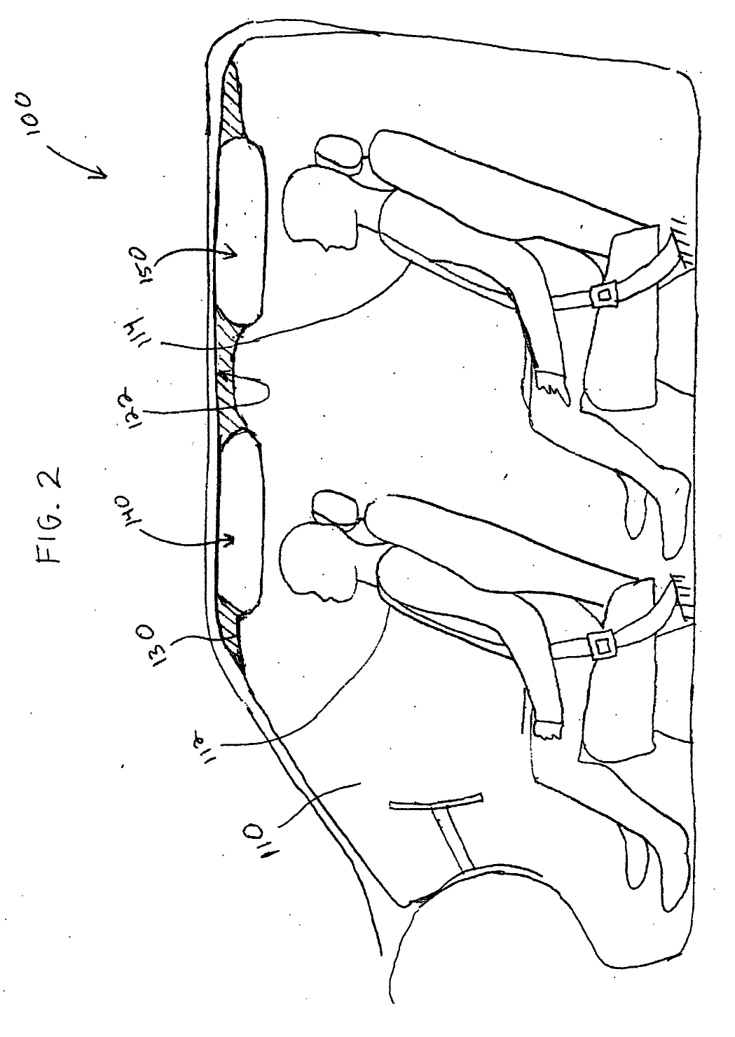

Referring now to FIG. 2, the vehicle 100 of FIG. 1 is illustrated with the airbags 140, 150 in a deployed state. As described above, the airbags may be deployed in the event of a rollover, a roof deformation or other such event. In the deployed state, the airbags 140, 150 from a cushion between the roof surface 122 and occupants of the vehicle, such as passengers 112, 114.

As the airbags 140, 150 are deployed, they may protrude from the headliner 130. In this regard, the headliner 130 may be adapted to tear when the airbags 140, 150 are inflated. Alternatively, the headliner 130 may be precut with perforations formed at selected area to allow the airbags 140, 150 to protrude therethrough. In other embodiments, the headliner 130 may be formed of sufficiently elastic material such that, when the airbags 140, 150 are deployed, the headliner 130 simply stretches and retains the airbags therein.

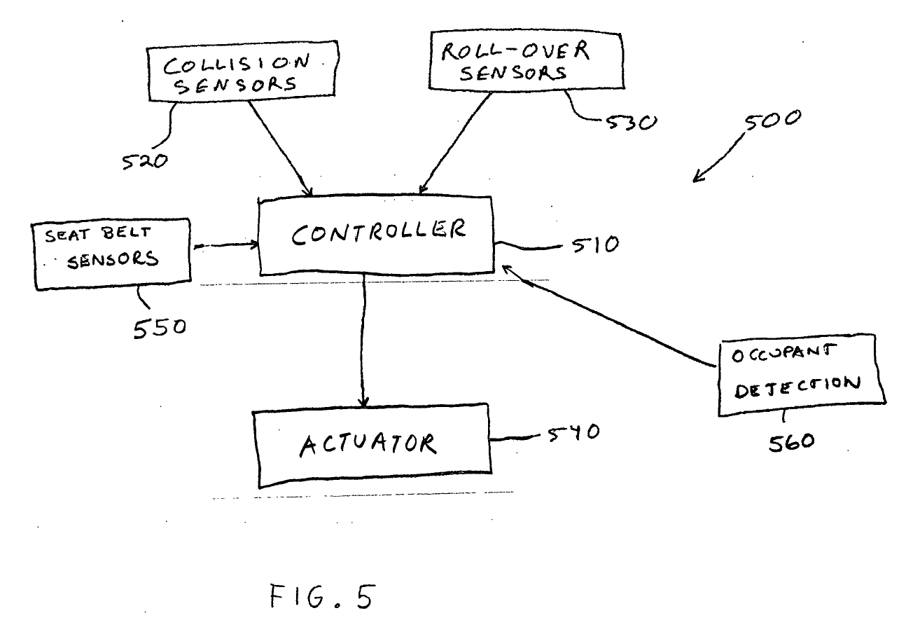

FIGS. 1 and 2 illustrates the vehicle 100 provided with two airbags 140, 150 within the headliner. In other configurations, a more or fewer airbags may be provided. For example, in one embodiment, a single airbag may be provided that is sufficiently large to protect all occupants of the vehicle. In other embodiments, a plurality of smaller airbags may be provided. For example, each seat may include a separate airbag for protecting the occupant of the seat. Furthermore, as explained below with regard to FIG. 5, each airbag may be controlled separately from the remainder of the airbags so that the deployment of the airbags may be controlled separately based on, for example, the classification of the occupant of the seat.

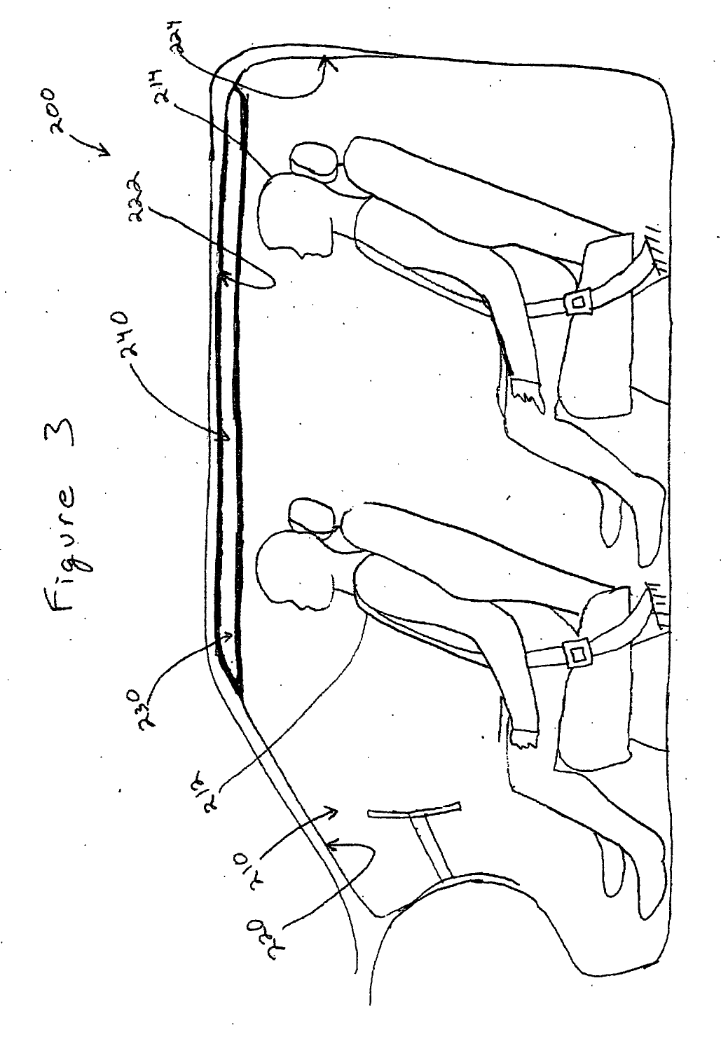

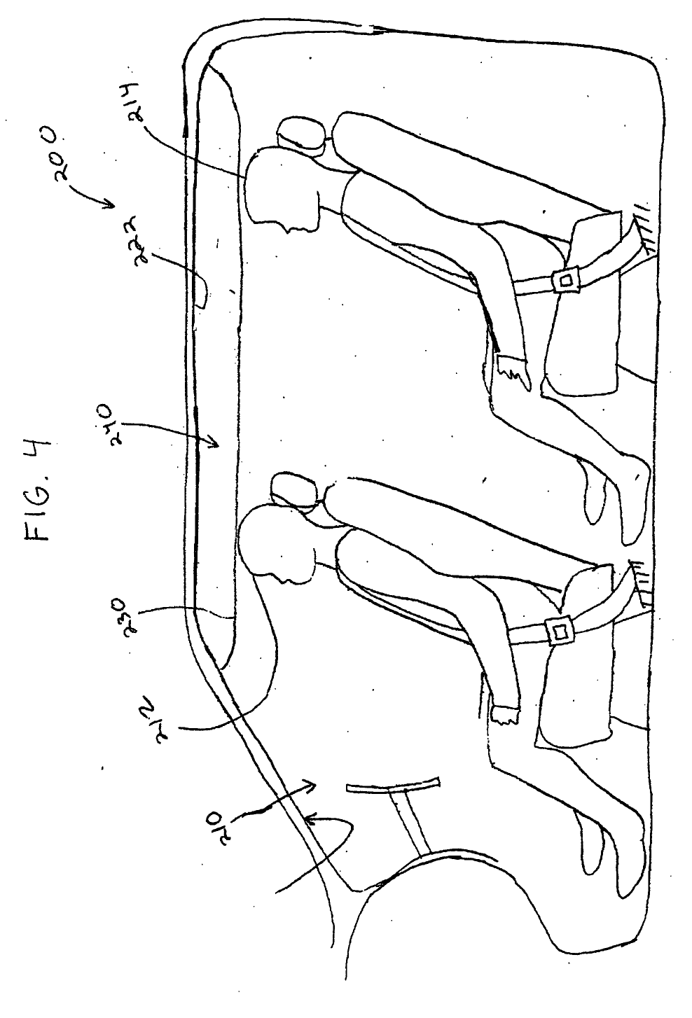

FIGS. 3 and 4 illustrate another embodiment of an airbag system according to present invention. FIG. 3 illustrates a vehicle 200 with an inflatable airbag 240 in an undeployed state. In the embodiment illustrated in FIG. 3, the inflatable airbag 240 is a cavity formed between the headliner 230 and the interior roof surface 222. In this regard, the headliner 230 forms a wall of the airbag 240. It is noted that, in the undeployed state, the cavity may have a negligible volume. In other words, the headliner 230 may be substantially flush against the interior surface 222.

FIG. 4 illustrates the airbag system of FIG. 3 in a deployed state. The inflation of the airbag 240 expands the cavity to provide a cushion between the passengers 212, 214 and the roof surface 222. As noted above, the headliner 230 itself serves as a wall of the airbag 240. Thus, the headliner 230 should be formed of a material that is sufficiently elastic and sufficiently strong to support the inflating pressure required for protection of the passengers 212, 214.

In another embodiment, the cavity forming the airbag 240 may be formed between two layers of the headliner. In this regard, as the airbag 240 is deployed, one layer of the headliner 230 may remain attached to the roof surface 222. The airbag 240 may be configured to inflate to a depth of as little as 0.5 inches. The relatively thin pocket of inflation gas will function to provide a cushion between the occupant's head and the roof surface. The airbag 240 may be stored in a substantially flat position between layers of the headliner. In one embodiment, a film airbag may be used to minimize the thickness of the headline containing the airbag. Furthermore, the airbag may be configured to deploy to a relatively thin depth in order to minimize the depth of the headliner containing the airbag.

FIG. 5 schematically illustrates one embodiment of an airbag control system 500. The vehicle control system 500 includes a central controller 510, which may be a part of a larger safety restraint system control system. The controller 510 may include a processor and a memory.

The airbag control system 500 also includes sensors to detect certain events. For example, one or more collision sensors may be provided to detect a front-end, rear-end, side-impact or other type of collision. Additionally, stability sensors may include one or more rollover sensors 530 to detect an imminent rollover or a rollover in progress. The sensors may be configured to sense vehicle characteristics such as, for example, acceleration or rotation angle which may be used to determine whether a collision is imminent or occurring. Further by way of example, the sensors may detect changes to the vehicle structure such as a crush sensor, pressure sensor or magnetic sensor that may detect a change in the vehicle structure resulting from a vehicle impact. The output from the collision sensors 520 and/or rollover sensors 530 may be used to determine whether the vehicle characteristics are such that roof deformation may be likely. Further, additional sensors may be provided to detect other types of safety-related events.

The controller 510 may be adapted to receive signals from the collision sensors 520 and the rollover sensors 530 at a regular frequency or only when the sensors detect an event or movement satisfying a predetermined threshold. Upon receipt of the signals, the controller 510 may process the signals to determine whether any action is required. For example, the controller may determine that the signals indicate a rollover condition. In this regard, the controller 510 may compare the signals to predetermined thresholds stored in the memory.

If the controller 510 determines that the signals indicate an event, such as a rollover with potential for roof deformation, requiring deployment of one or more airbags, a signal may be transmitted from the controller 510 to one or more actuators 540. Such actuators 540 may be coupled to inflation devices, such as compressed gas canisters, for example. The actuation of the inflation devices can rapidly inflate the airbags, providing a cushion between the roof surface and occupants of the vehicle. Alternatively, the actuators 540 may actuate other safety devices such as, for example, seat belt pretensioners, motorized retractors or any other safety related device.

The controller may also be configured to receive inputs from a seat belt sensor 550. The seat belt sensor may detect the tension in the seat belt and/or whether the seat belt is buckled. In an embodiment of the invention, the controller 510 inhibits or prevents deployment of the airbag if the seat belt sensor indicates that the seat belt is not buckled. The controller may also be configured to receive inputs from a occupant detection and classification system 560. The occupant detection system may classify the occupant of a vehicle seat based on any of a number of well known methods including, for exemplary purposes only, weight sensing, belt tension, proximity sensors, ultrasonic and other methods. If the controller 510 is configured to deploy the airbag based on the type of occupant classified to be in the vehicle seat. The controller 510 may also be configured to initiate other safety devices such as, for example, seat belt pretensionser to remove belt slack and more tightly retain the occupant to the seat.

The foregoing description of embodiments of the invention have been presented for purposes of illustration and description. It is not intended to be exhaustive or to limit the invention to the precise form disclosed, and modifications and variation are possible in light of the above teachings or may be acquired from practice of the invention. The embodiment was chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

What is claimed is:

1. A vehicle airbag system, comprising:
an inflatable airbag positioned on an interior surface of a vehicle, the vehicle including a roof surface and one or more side surfaces;
wherein said airbag, when deployed, is adapted to inflate to a location between the roof surface and occupants of the vehicle.

2. The system of claim 1, wherein said inflatable airbag, when undeployed, is positioned within a headliner on the roof surface.

3. The system of claim 2, wherein said inflatable airbag includes one or more fabric bags positioned between the headliner and the roof surface.

4. The system of claim 3, wherein said inflatable airbag, when undeployed, is folded in pleats within the headliner.

5. The system of claim 3, wherein said inflatable airbag, when deployed, protrudes through the headliner.

6. The system of claim 2, wherein said inflatable airbag is a cavity formed between the headliner and the roof surface.

7. The system of claim 6, wherein, when the airbag is deployed, said cavity expands to form a cushion.

8. The system of claim 1, further comprising:
at least one sensor to facilitate detection of a rollover of the vehicle; and
a controller adapted to deploy the inflatable airbag when a rollover is detected.

9. The system of claim 8, wherein the controller is further adapted to actuate one or more actuators to inflate the airbag when a rollover is detected.

10. The system of claim 2, wherein the headliner includes a plurality of layers and wherein one of the layers includes an airbag.

11. The system of claim 1, further comprising a sensor for detecting whether a seat belt is buckled and a controller configured to prevent deployment of the airbag when the seat belt is not buckled.

12. The system of claim 1, further comprising a system for detecting and classifying the occupant of a vehicle seat and a controller configured to control the deployment of the airbag based on the results of the occupant classification.

13. A method for providing airbag protection for vehicle occupants, comprising:
detecting a rollover; and
deploying one or more airbags, at least one or the airbags being an inflatable airbag positioned on an interior surface of a vehicle, said inflatable airbag, when deployed, being adapted to from a cushion between the roof surface and occupants of the vehicle.
